(19) United States
(12) Patent Application Publication
(10) Pub. No.: US 2009/0173581 A1
(43) Pub. Date: Jul. 9, 2009

(54) Air Tool Oil Apparatus

(75) Inventors: Russell Jackola, Beach Park, IL (US); Douglas Fairbanks, Beach Park, IL (US)

Correspondence Address: BANNER & WITCOFF, LTD., TEN SOUTH WACKER DRIVE, SUITE 3000, CHICAGO, IL, 60606, US

(73) Assignee: Small Car Motors, Inc., Beach Park, IL (US)

(21) Appl. No.: 12/338,253

(22) Filed: Dec. 18, 2008

Related U.S. Application Data
(60) Provisional application No. 61/014,632, filed on Dec. 18, 2007.

(51) Int. Cl. F16N 27/00; B05B 11/02; F16N 13/08

(52) U.S. Cl. 184/7.4; 222/631; 184/38.1

(57) ABSTRACT

An air tool oil apparatus is disclosed that may be used by all automotive mechanics to provide easy and convenient maintenance of all air tool equipment. The air tool apparatus may include a holding tank, a top portion and a bottom portion. The top portion may include a vent and a fill plug. The bottom portion may include a nozzle and a drain valve positioned above the nozzle. The apparatus may further include a valve actuator configured to open and close the drain valve. The valve actuator may be embodied in different forms including a side mounted push-button, a lever, and a movable nozzle.

### CROSS REFERENCE TO RELATED APPLICATION

This application is a non-provisional application of and claims benefit to U.S. Provisional Application Ser. No. 61/014,632 filed Dec. 18, 2007.

### FIELD OF THE INVENTION

The present invention relates generally to air tool equipment and, more particularly, to an apparatus for maintaining air tool equipment.

### BACKGROUND OF THE INVENTION

It is known that air tool equipment is used by automotive mechanics for various applications. It is also known that maintenance of air tool equipment is necessary to ensure the longevity and proper use of the air tool equipment. The present invention is directed at providing a device that ensures the proper maintenance of air tool equipment.

### BRIEF SUMMARY OF THE INVENTION

The present invention, as more fully described below and shown in the figures, provides an air tool oil apparatus that may be used by all automotive mechanics to provide easy and convenient maintenance of all air tool equipment.

At least some embodiments of an oil apparatus include a holding tank for holding oil. A top portion may include a vent to aid in oil flow and a fill plug for filling the holding tank with oil. A bottom portion includes a nozzle and a drain valve positioned above the nozzle 32 or dispensing oil from the holding tank. A valve actuator opens and closes the valve. The oil apparatus may include a mounting member configured to attach the apparatus to a surface such as a wall or a tool box.

In at least one embodiment, the valve actuator is a side mounted push-button that located in the bottom portion. In another embodiment, the valve actuator is a side mounted push-button located in the top portion, which is engaged to a rod configured to open and close the drain valve. A further embodiment of the valve actuator is a lever attached to a rod configured to open and close the drain valve.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 depicts an exploded view of an exemplary oil tool apparatus of the invention.

FIG. 2 illustrates a front view of an alternative embodiment of the exemplary oil tool apparatus.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### DETAILED DESCRIPTION OF THE EMBODIMENTS

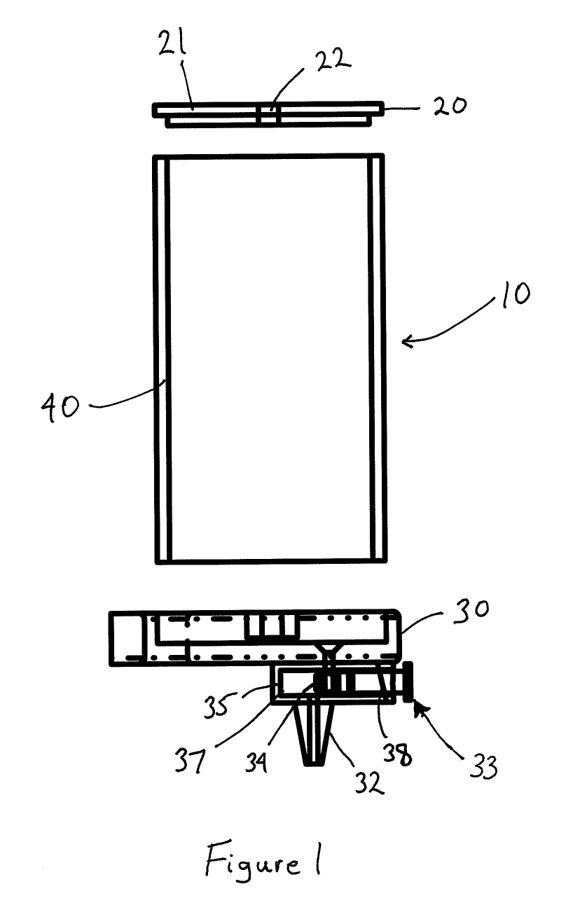

Referring to FIG. 1, an exemplary air tool oil apparatus 10 of the invention is depicted in an exploded view. The oil apparatus 10 may be used to lubricate most air tool equipment used by mechanics and others to ensure the proper maintenance and longevity of such equipment. The oil apparatus 10 may be gravity run and may define a cylinder/holding tank 40 made of polycarbonate, aluminum or any other suitable material. Other suitable materials may include stainless steel, composite metals and cast iron. The top 20 and bottom 30 of the oil apparatus 10 may be made of aluminum, or other suitable material, which may be made in various colors to match different tool box colors.

The bottom 30 of the oil apparatus 10 may have two side mounted ears 31 that may protrude out both sides, and may include drilled holes for easy mounting of the oil apparatus 10. The drilled holes may receive a fastener such as a nail or a screw to secure the oil apparatus 10 to a surface. In alternate embodiments, the oil apparatus may be mounted magnetically to a surface. For example, a magnetic mounting member may be attached to the bottom 30 of the oil apparatus 10 or to the holding tank 40. The mounting member may be manufactured as an unitary portion of the oil apparatus 10 or may be attached to the oil apparatus 10 by any suitable means such as adhesives. The oil apparatus 10 may be mounted to a surface such as a wall or a tool box. The oil apparatus 10 and holding tank 40 may vary in size to accommodate different amounts of oil. For example, the holding tank 40 may hold 2 oz. of oil or 16 oz. of oil.

In an exemplary embodiment of the invention, the oil tool apparatus 10 may include a hex top mounted fill plug 22, a top vent 21 for better oil flow, a side mounted push-button 33 for oil release which distributes oil through an aluminum threaded tip or nozzle 32, which is located on the bottom 30. A bottom oil drain valve 35 may have a horizontal drilled hole with a machined center 34 for oil flow when the oil release button 33 is pushed toward the drain valve 35, with a spring 37 at the base of the hole to return the push-button oil release 33 to its original position. O-rings 34 may be positioned at both sides of the drain valve 35 to keep oil from leaking toward the spring 37 or button 33. A circlip 38 may be used to keep the push-button oil release 33 in the oil apparatus 10 and a rubber cap 36 may be positioned over the oil release button 33.

In at least one embodiment, the top 20 corresponds to a top portion attached to a top end of the holding tank 40 and the bottom 30 correspond to a bottom portion attached to a bottom end of the holding tank 40. The top portion and the bottom portion may be part of a unitary construction with the holding tank 40 or may be separable from the holding tank 40. In one embodiment, the top portion and the bottom portion are threadably engaged to holding tank 40. In different embodiments, either the top portion or the bottom portion may be configured with a valve actuator for opening and closing the drain valve 35 to dispense oil from the holding tank 40. The nozzle 32 may be formed as a unitary piece of the bottom portion or may be threadably engaged to the bottom portion.

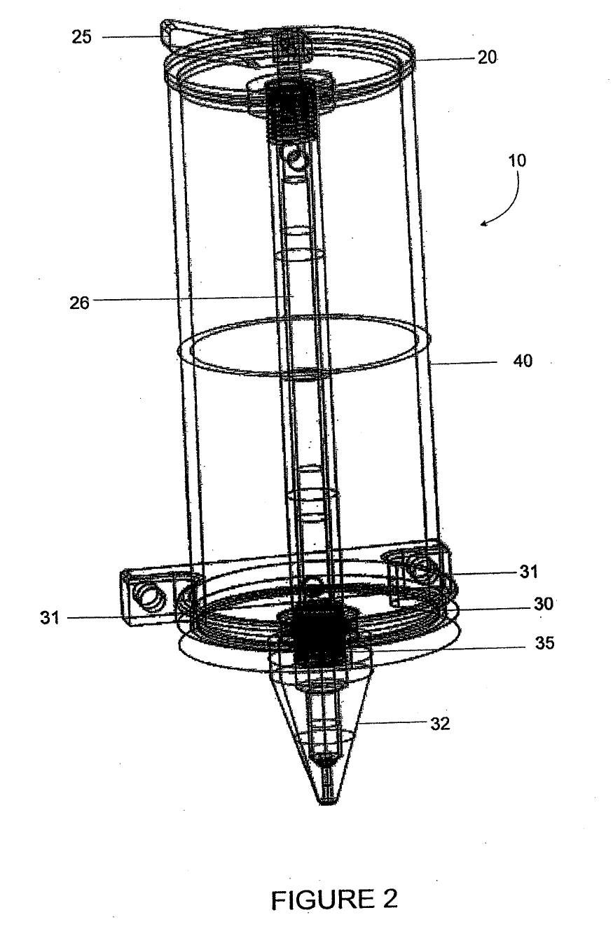

In one embodiment, the valve actuator is a side mounted push-button positioned in the top portion. In this embodiment, the push-button may be attached to a rod 26 (FIG. 2) in such as way that the horizontal movement of the push-button is translated into vertical movement of the rod 26 to open and close the drain valve 35. The push-button may include a biasing member such as a spring that compresses when the push-button is depressed towards the oil apparatus 10 and returns the push-button to a non-depressed position. The drain valve 35 may be any suitable type of valve for dispensing oil. For example, the drain valve may be a ball valve or a butterfly valve.

Referring to FIG. 2, a front view of the oil apparatus 10 with an alternate embodiment of the valve actuator is illustrated. As depicted in FIG. 2, the valve actuator is a lever 25 positioned on the top portion. In this embodiment, movement of the lever 25 moves a rod 26 that extends through the holding tank 40 to the drain valve 35. For example, when the lever 25 is pushed upwards the rod 26 moves in a downward direction, which opens the drain valve 35. When the lever 25 is pushed down, the rod 26 moves in an upward direction to close the drain valve 35. Alternatively, the valve actuator could be a lever positioned on the side of the oil apparatus 10 that operates in the same manner as the top mounted lever 25 described above. In a further embodiment, the valve actuator may also be a lever, similar to the top mounted lever 25 that is positioned in the bottom portion or near the bottom 30. In this embodiment, the lever may be attached to a horizontal or substantially horizontal rod engaged with the drain valve 35, which opens and closes the drain valve 35 when the lever is moved between a first position and a second position.

In another embodiment, the valve actuator is internal to the nozzle 32. In this embodiment, the drain valve 35 is opened when the nozzle 32 is pressed upwards and closed when the nozzle 32 returns to its original position. The nozzle 32 may include a biasing member such as a spring to return the nozzle 32 to its original position. In this embodiment, the oil apparatus 10 dispenses a pre-determined amount of oil when the drain valve 35 is opened.

In one embodiment, the oil apparatus 10 includes a manually operated pump. The pump may dispense a pre-determined amount of oil or fluid out of the nozzle 32. The pump may be positioned at any suitable location within the oil apparatus 10. For example, the pump may be positioned at the bottom 30 or the top 20 of the oil apparatus 10. In this embodiment, the pump is connected to the nozzle 32 to allow dispensing of the fluid. The pump may also include a self shut-off valve.

In at least some embodiments, the oil apparatus 10 includes a plurality of sealing members to keep oil from leaking out of the valve. In one embodiment, as illustrated in FIG. 1, two O-rings 34 (FIG. 1) are positioned on opposite side of the drain valve 35 to keep oil from leaking toward the spring or button. A circlip 38 may be used to keep the valve actuator in the oil apparatus 10.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. An air tool oil apparatus comprising:
a holding tank;
a top portion having a vent and fill plug;
a bottom portion having a nozzle and a drain valve positioned above the nozzle;
a valve actuator configured to open and close the drain valve;
a mounting member configured to attach the apparatus to a surface.

2. The apparatus of claim 1, wherein the valve actuator is a side mounted push-button in the bottom portion.

3. The apparatus of claim 2, wherein the side mounted push-button includes a biasing element configured to return the push-button from a depressed position to a non-depressed position.

4. The apparatus of claim 1, wherein the valve actuator is a lever is positioned on the top portion and attached to a rod extending through the holding tank.

5. The apparatus of claim 1, wherein the valve actuator is integral with the nozzle such that pressing up on the nozzle dispenses a pre-determined amount of oil.

6. The apparatus of claim 1, wherein the valve actuator is a side mounted push-button positioned on the top portion and attached to a rod extending through the holding tank.

7. The apparatus of claim 6, wherein the side mounted push-button includes a biasing element configured to return the push-button from a depressed position to a non-depressed position.

8. The apparatus of claim 1, wherein the mounting member includes two ears, each ear extending from opposite sides of the bottom portion and defining an aperture for receiving a fastener.

9. The apparatus of claim 1, wherein the mounting member is magnetic and engages with a metallic surface.

10. The apparatus of claim 1, further comprising:
a plurality of sealing members surrounding the drain valve.
